(19) United States
(12) Patent Application Publication
(10) Pub. No.: US 2020/0250596 A1
(43) Pub. Date: Aug. 6, 2020

(54) METHOD AND SYSTEM FOR ROUTE SPECIFIC AIRCRAFT LIABILITY DETERMINATION

(71) Applicants: Suzette Matthews, Marshall, VA (US); Vitali Vitalievich Volovoi, Alpharetta, GA (US); David E. Schaffer, Vienna, VA (US); Karen Risa Robbins, Healdsburg, CA (US); Frank Leo Frisbie, Crofton, MD (US)

(72) Inventors: Suzette Matthews, Marshall, VA (US); Vitali Vitalievich Volovoi, Alpharetta, GA (US); David E. Schaffer, Vienna, VA (US); Karen Risa Robbins, Healdsburg, CA (US); Frank Leo Frisbie, Crofton, MD (US)

(21) Appl. No.: 16/243,013

(22) Filed: Jan. 8, 2019

Related U.S. Application Data
(60) Provisional application No. 62/614,665, filed on Jan. 8, 2018.

(51) Int. Cl. G06Q 10/06; G06F 16/29; G08G 5/00; G06Q 50/28

(52) U.S. Cl. CPC G06Q 10/0635; G06Q 50/28; G08G 5/003; G06F 16/29

(57) ABSTRACT

A computer implemented method and computer system generating dollar value estimates of the value of persons and property at risk along an aircraft route, taking into account the aircraft's physical and operating characteristics. The system comprises a property and population datasets, maps dataset for a user interface to select a route and specifying an aircraft's physical and operational characteristics.

### CROSS REFERENCE TO OTHER APPLICATIONS

This application claims priority under 35 U.S.C. § 119(e) of the co-pending U.S. provisional patent application Ser. No. 62/614,665 filed on Jan. 8, 2018 entitled “A METHOD AND SYSTEM FOR ROUTE SPECIFIC LIABILITY PROBE DETERMINATION.” The provisional patent application Ser. No. 62/664,615 filed on Jan. 8, 2018 entitled “A METHOD AND SYSTEM FOR ROUTE SPECIFIC LIABILITY PROBE DETERMINATION” is hereby incorporated by reference in its entirety.

### FIELD OF INVENTION

The present invention relates to software methods and computer systems for generating dollar value estimates of the value of persons and property at risk along an aircraft route, taking into account the aircraft's physical and operating characteristics. For the purpose of this application risk is defined as and limited to dollar damage to third-party property, injury liability to persons, or both. More particularly, the present invention is in the field of evaluating a route based dollar value third-party liability risk by taking into account property values and population densities along a proposed flight route. Further, the evaluation incorporates the characteristics of the aircraft's speed, weight, reliability, and frangibility in evaluating the route risk. Additionally, the invention can include software and computer systems that generate alternative route offerings ranked according to third-party damage liability risk.

What is needed are computer methods and systems that generate a dollar value third-party potential damage/liability risk assessment of a flight route or comparative flight routes taking into account the population and property values along the proposed route and modified by physical and operating characteristics of an aircraft. Further, what is needed are systems and methods that uniquely output dollar value third-party liability that enables the user to make easy comparative judgements about various routings based on the potential third-party damage/liability.

### BACKGROUND

Prior methods of aircraft route planning have been based on distance, or the fastest or most economical in terms of operating costs route incorporating weather, winds, and airspace. These prior methods did not incorporate the risk to populations and property traversed within the planned route. Thus, prior art systems are not adequate for estimating the value of property or persons at risk under a proposed route and are therefore not useful tools for assessing risks to the non-participating public and/or legal liability risks to the aircraft operator inherent in a particular operation for operator planning, regulatory decision making or insurance underwriting. Thus, a system that provides route planning based on potential third-party property damage and population risk is a great improvement to the technical field of aircraft route planning for not only aircraft operators, but for others including but not limited to regulators, policy makers, insurance companies, and stakeholders. There is no currently known system that evaluates the potential third-party damage liability and third-party personal injury liability based on discrete property values and population densities along a route. No system is known that outputs to a user in dollars route analyses and choices that allow easy comparative judgements among various routings based on the potential third-party damage and if desired the potential liability of various routes.

### SUMMARY OF THE INVENTION

In one aspect of the invention, a computer system provides a means for generating dollar value estimates of the value of persons and property at risk along an aircraft route, taking into account the aircraft's physical and operating characteristics. The system includes a component configured to receive an aircraft route having a starting and ending point within an area. Another system component is configured to receive or access one or more aircraft's physical and operational characteristics. These characteristics include aircraft speed, weight and frangibility. Another component(s) of the system accesses one or more digital-datasets containing population and property data associated with a geographic area.

The system, once receiving a route and aircraft risk characteristics, then associates the route with the property and population within the digital-datasets. A calculation is then made of the risk to the property and population by the aircraft along the route as a monetary value.

Optionally, the system can display sections of the route that have higher risk than others. Also optionally, the system can determine a route with lower risk by calculating a risk gradient along the route, and computing a new route with lower risk.

In another aspect of the invention, a method for estimating a specific aircraft route liability is disclosed. The method includes the steps of providing a property digital-dataset and a population digital-dataset for a geographic area. Additionally, an aircraft's risk characteristic and a route are provided. The route is associated with the property and population that is found within the digital-datasets.

### BRIEF DESCRIPTION OF THE DRAWINGS

FIG. 1 is a block diagram of the Route Specific Liability Probe system.

FIG. 2 is a first embodiment of a process flow diagram of the Route Specific Liability Probe method.

FIG. 3 is a second embodiment of the of a process flow diagram of the Route Specific Liability Probe method.

FIG. 4 is a graphical user interface of the process flow diagram.

FIG. 5 illustrates a grid map overlay of a property or population dataset.

FIG. 6 illustrates irregular shaped geospatial units map overlay of a property or population dataset.

### DESCRIPTION OF THE INVENTION

The following description is provided as an enabling teaching of several embodiments of the invention disclosed. Those skilled in the relevant art will recognize that many changes can be made to the embodiments described, while still attaining the beneficial results of the present inventions. It will also be apparent that some of the desired benefits of the present invention can be attained by selecting some of the features of the present invention without utilizing other features. Accordingly, those skilled in the art will recognize that many modifications and adaptations to the present invention are possible and can even be desirable in certain circumstances, and are a part of the present invention. Thus, the following description is provided as illustrative of the principles of the present invention and not a limitation thereof.

The Route Specific Liability Probe (RSLP) system is a computer tool that assesses and quantifies in dollar values the potential third-party damage liability risk associated with a particular route operated by a specific aircraft. The liability risk can include third-party property damage, third-party personal injury liability, or both.

For the purpose of this invention and the invention, the use of the word “mishap” or “aircraft mishap” relates only to events would cause the aircraft to cause damage to third-party property or third-person injury.

### RSLP Server

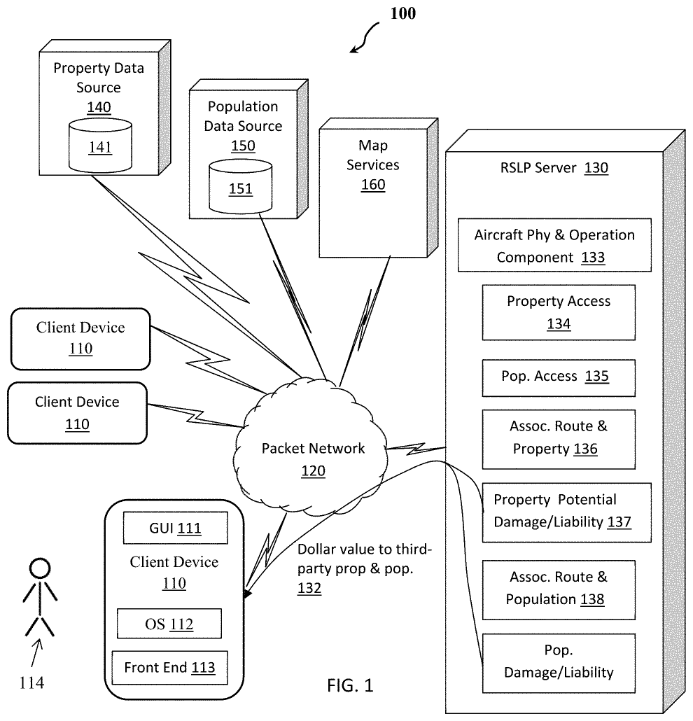

In one aspect of the invention FIG. 1 shows a RSLP system. The system enables a user 114 to select on a computer 110 a proposed route and determine the third-party liability/risk associated with the selected route based on either the population along the route, the property overflown along the route, or both and further factoring in the physical and operational characteristics of the aircraft. The RSLP system outputs a dollar value estimate of the value of third-party property damage and third-party personal injury risk along an aircraft route. The In one embodiment of the invention, an alternative route can be identified by calculating gradients of risk along the route. Alternatively, an indicator of route segment having higher average liability can be displayed or highlighted to a user.

For the purpose of the disclosure and invention, the use of the word “risk” is limited to the probability that an aircraft mishap or malfunction results in the aircraft damaging property and causing personal injury, per unit of time weighted by the flight time over property, population, or both, and each weighted by risk/liability characteristics of an aircraft and this population and property overflown. The liability or risk characteristics of the aircraft are discussed further below. In general weight and aircraft velocity factors into kinetic energy of the aircraft and affects the probability that property damage or personal injury will occur.

FIG. 1 shows the system configuration 100 of one aspect the invention. While different computer components are shown separately, these components could be located within the same computer or server. Alternatively, components within the same computer could be located on other computers and servers where the computational systems communicate over a packet network and thereby provide for a distributed processing system.

In the shown embodiment, the RSLP server 130 communicates with client devices 110 over the packet network 120. As shown, the client devices 110 can be a separate computer and configured with an operating system 112 having a GUI (graphical user interface) 111. Alternatively, the GUI 111 and operating system 112 could execute within the RSLP Server 130. The client device 110 includes but is not limited to a desk-top computer, a smart phone, or a tablet device.

### Front End Component

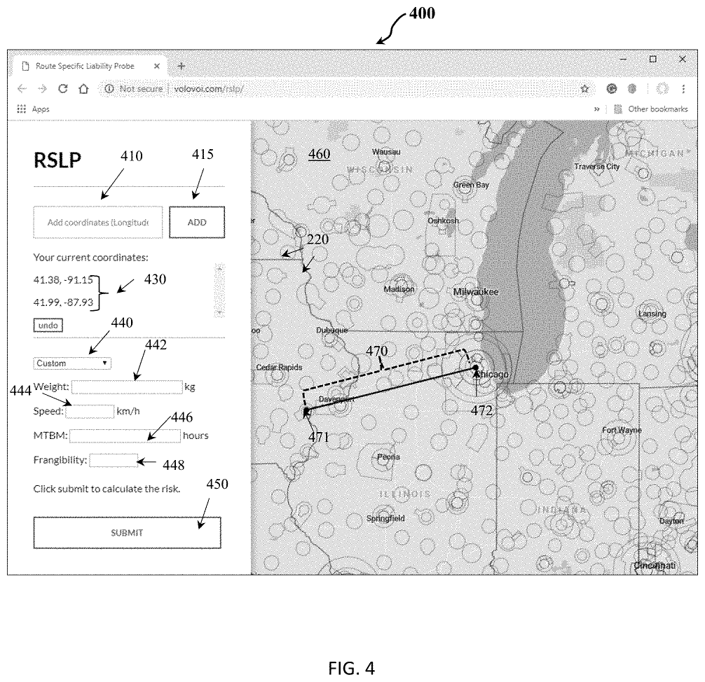

One system component is the front-end 113. As shown, the front-end component 113 is shown located in the client device 110. The front-end component 113 provides a means to interact with a user, provides the GUI window functionality, establishes the connectivity to the RSLP server 130 through the network 120, and receives and displays the generated dollar value estimates 132 of the value of persons and property at risk along an aircraft route, factoring in the aircraft's physical and operating characteristics. The front-end component 113 consists of an interactive map and a menu that enables a user to input aircraft risk related parameters, scroll a map, specify a route, zoom in and out, navigate around the map, and the display a route. One example of a user interface controlled by the front end component 113 is shown in FIG. 4.

### Map Service Component

The map service component 160 provides a client-server pairing that enables configured map styles and the relevant preloaded data (such as airspace boundary to be uploaded on the server 130 side, and further manipulate the maps on the client side 110 by including appropriate calls to the server 130 into the front end web page that loads the maps. Also, the map service component 160 enables drawing a route as a separate layer on the map locally.

The map service component 160 can be a commercially service located on a server separate from the RSLP server 130. Exemplar of mapping services are MapBox® or Google® Maps.

### Aircraft Risk Component

The aircraft risk component 133 is a software component or module that is part of the RSLP system 100. Note that aircraft risk is limited to risks that would cause the aircraft to cause third-party property damage of personal injury to people along a specified route. The aircraft risk component 133 is configured to receive aircraft physical and operational characteristic.

These risk characteristics can be manually entered through the GUI 111 or by selecting a specific aircraft where the aircraft physical and operational characteristics are pre-specified. FIG. 4 shows one embodiment of a software window 400—FIG. 4 of the GUI 111 that includes the aircraft risk characteristics.

The software window 400, as shown in FIG. 4, can include but is not limited to manual entry boxes for the aircraft risk characteristics weight 442, speed 444, MTBM (mean time between mishap) 446, and frangibility 448. Note, that “mishap” is defined, for the purpose of this inventions, an aircraft problem that would cause third-party property damage or personal injury. Frangibility 448 relates to the aircraft and its ability to break or fracture.

A dropdown menu 440 can be used to select an aircraft model or type that has a preconfigure risk characteristic including weight, speed, MTBM, and frangibility. Further, the software window 400 includes an entry box 410 for specifying and entering 415 route coordinates. Alternative, a user can use a mouse to select on the map 460 the route end points 471, 472. The longitude and latitude of the selected end points 471, 472 or way points are displayed 430 in the window 400.

### Property Access Component

The property access component 134, is software that provides access to a property digital-dataset 141 that contains property value information. The property dataset 141 is a set of digital geospatial units with associated property values. This property dataset 141 can be local (not shown) to the RSPL server 130 or can be a network connected 120 property data server 140.

The property digital-dataset 141 can be a database organized for quick searching. The property dataset 141 geospatial units can be organized as a grid, 510—FIG. 5. One organization is to index the database by State and thereby reduce the search time. Further, the database 141 can be indexed by longitude or latitude of each grid area. The grid size can be fixed or variable but is typically fixed size with equal length on the longitude and latitude sides. Alternatively, the digital-dataset 141 can include the longitude and latitude of each grid or geospatial unit corner forming the geospatial unit.

The dataset 141 can include the average property value in the grid or geospatial unit but other formats are contemplated. Further, the property dataset can include information regarding the type of property or other characteristics that can be used to estimate the damage that might be incurred by an aircraft mishap. One skilled into the art of accessing and processing database information would know how to access specific data, related to the route, from the database 141 in the most efficient manner.

Exemplar of one data source is government census data which contains the geographic coordinates of a census area and information regarding property value. Other sources of property data are contemplated by the invention. These can include, but are not limited to private data sources such as Zillow®, real estate databases, and satellite imagery.

### Population Access Component

The population access component 135, is a software module that provides access to a population digital-dataset 151 that contains population density information. This population dataset 151 can be local (not shown) to the RSPL server 130 or can be a network connected 120 to a population data server 150.

The population digital-dataset 151 can be a database organized as described above for the property dataset 141. Further, the property dataset 141 can be part of the same dataset and located on the same server and include both population and property data covering the same grid or spatial unit.

### Property Association & Population Association

The property association component 136, and population association component 138 provides the computer association of the user selected route 470 selected by a user utilizing the front end 131 and map services 132, with the property dataset information and population data set information. The property dataset information and the population dataset information can be digitally stored as grids or as irregularly shaped geospatial units.

Referring to FIG. 5, a representation of a map grid overlay is shown. FIG. 5 just represents the overlay. In the shown embodiment, the grid data is digitally stored with the longitude and latitude coordinates of each grid and a corresponding property value or population density. The grid data 511a, 511b are two of the grids that are associated with the route 470. The property dataset information is accessed by the property access component 134 and the population dataset information is access by the population access component 135.

The property association component 136 determines two items of data regarding the route. First, the property data set needs to be searched or accessed based on the route 470 path to determine which grids are crossed by the route 470. Secondly, the distance crossing the property dataset grid, 512—FIG. 5 for example, needs to be determined. The distance is important because when combined with the aircraft speed, it determines the overflight time for the grid.

The resulting property association generates an array containing the grids transected by the route, the route distance across the geospatial unit, and the property value density for the grid. Alternatively, the property dataset 141, or population dataset 151 can be irregularly shaped geospatial units.

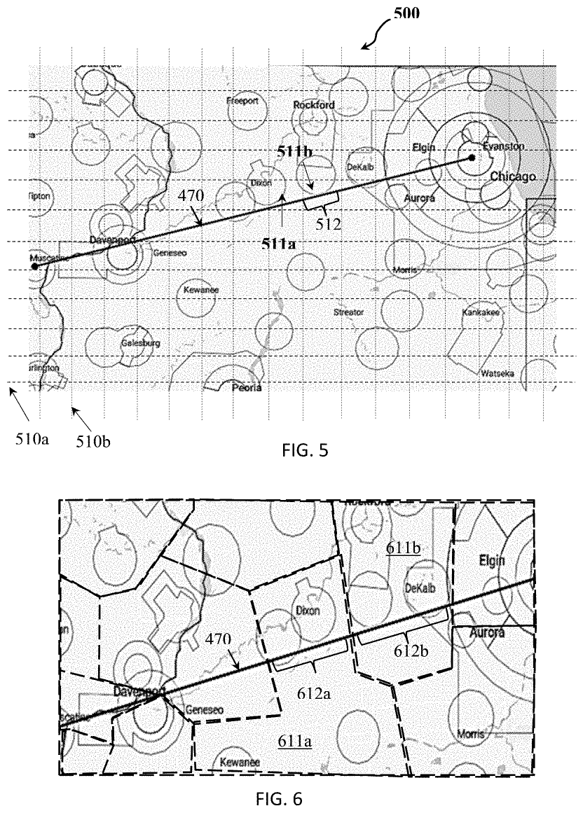

FIG. 6 illustrates a dataset overlaid on a map with irregularly shaped geospatial units 611a, 611b. The property association generates the same array of geospatial units transected by the route 470, the route distance across the grid 612a, 612b, and the property values for the geospatial unit. Only a different method is required to calculate the route distance 611a, 611b across the geospatial units is required. One skilled in the art of object detection in image processing would be able to determine these distances.

### Property and Population Risk Calculation

The property risk component 137, and population risk component 138 respectively generates a dollar value estimates of the value of third-part property and persons at risk along an aircraft route, taking into account the aircraft's physical and operating characteristics. The array generated by the property association component 136 and population association component 138 are used to determine the length of time the aircraft would be within the grid or geospatical unit transected by the route 470. Then aircraft risk component 133 accesses the aircraft parameters that are used in the risk/liability calculation. One embodiment for the risk formula is calculated as follows:

The risk calculations for the population risk have the following form:

Rₕᵤₘₐₙ=Pₘ×Cₕ×A_{d}×Vₕ

Here the contributing factors are:
Pₘ denotes the probability of mishap that depends on the aircraft reliability, and the exposure time (time spend in the particular geographical or geospatial unit): Pₘ=mₜ×dₜ/Vₐ
mₜ is the mean time between mishaps; dₜ is the traversed distance in the relevant geographical unit (e.g., census tract); and Vₐ the aircraft ground speed
Cₕ is the consequence coefficient, which for human risk is the product of the aircraft Fₐ frangibility (i.e., ability to produce damage upon an impact) and the Sₑ shelter effectiveness: Cₕ=Fₐ×Sₑ.
A_{d} represents the affected damage area. In the prototype, the linear relationship between the weight of the aircraft Wₐ and the affected area is used: Ad=C₀+C₀×Wₐ
Vₕ represents the “value density” uploaded in the tables from the offline—for human risk this implied the population density per unit area times the insurance value of human life, Iₛ

Vₕ=Iₛ*Nₜ/Aₜ
here Nₜ is the total population for the geographical unit (e.g., tract) and Aₜ is the corresponding total area of the unit (obtained by adding the land and water areas). Similarly, for the property risk:

R_{property}=Pₘ×Cₚ×A_{d}×Vₚ

Here the Pₘ and A_{d} are the same as used for human risk in Eq. 1, and
Consequence coefficient Cₚ that for property is simply equal to the aircraft frangibility Cₚ=Fₐ.
“Value density” Vₚ for property risk this implies the property values density per unit area:

Vₚ=Mₜ×Hₜ/Aₜ
here Mₜ is the mean price of a house and Hₜ is the total number of households in the geographical unit.

Once the dollar value estimates 132 of the value of property and persons at risk along an aircraft route, taking into account the aircraft's physical and operating characteristics is calculated, the estimates(s) 132 are sent to the user device 110 for display and user 114 evaluation.

### Data Sources

One data source is government census data which contains the geographic coordinates of a census area and information regarding property and income values. Data services can be provided by data providers which provide an interface to which a data connection can be made. These services provide information including property values, population, and the distances of two data points across a grid. Other sources of property data are contemplated by the invention.

The RSPL 130 can generate useful risk information just utilizing the property dataset or just the population dataset. However, it is preferred to utilize both data sets to estimate route risk and liability.

### RSLP Method

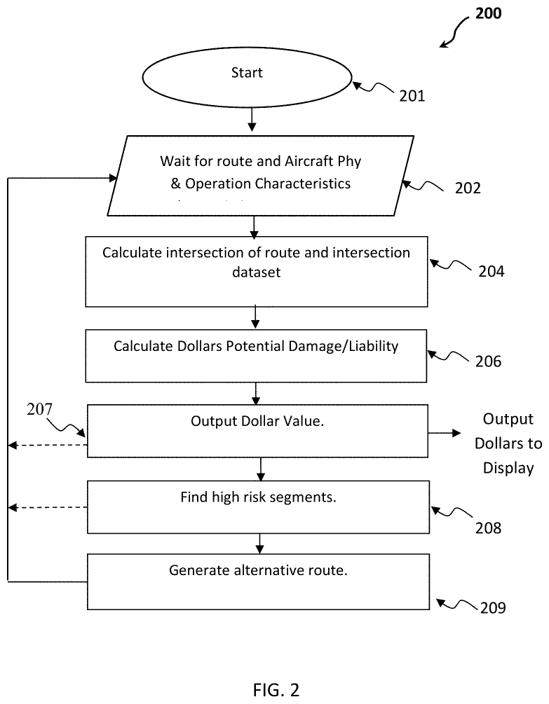

Referring to FIG. 2, a method is described for generating a dollar value estimates of the value of third-party property and persons at risk along an aircraft route, taking into account the aircraft's physical and operating characteristics. The method 200, includes receiving digital population and property grid data or geospatial unit data, determine a property and population grid or geospatial units associated with a route, and calculating the dollar value estimates of the value of persons and property for the route based on the aircraft physical and operational characteristics.

In a first step 201, the methods start. In this step the RSLP method is initialized. Any access connections to property and population datasets are configured. In one embodiment, the datasets can be downloaded. In another embodiment, initialization can included setting up network communication with servers that provide property and population data when accessed.

In a step 202, the software method waits for a route having a starting point and an ending point and for aircraft physical and operational characteristics. This route information can be generated by a user remotely located on another computer. Preferably, the route information is provided as starting and ending longitude and latitude for each route point. The aircraft risk characteristics can include but are not limited to speed, weight, frangibility, and mean time between mishaps.

In a step 204, the route is mapped onto the property and population dataset grids or geospatial units. The property and population datasets represent grids or geospatial units with associated population property and density value densities. The grids and geospatial units are as described above and shown in FIG. 5 and FIG. 6.

This step identifies the grids or geospatial units transected by the user selected route. For each of the grids or geospatial units within the population and property dataset intersected by the route, the distance of route crossing the grid or geospatial unit is computed and associated with the grid information. The distance of each associated route crossing a grid or geospatial unit is used with the aircraft speed to determine the time that the aircraft is within that area. In a subsequent step, when the associated route is multiplied with the mean time between aircraft mishaps, a probability is generated of there being an aircraft incident within that area.

Determining the distance of the route across the grid is simple geometry for a square or rectangular grid. To determine the crossing of a geospatial unit, the sides of the unit would have to be searched to find the intersection of the route with the side of the geospatial unit. One skilled in the art of geometric calculations would be able to determine the distance of each route crossing a grid or geospatial unit.

In a step 206, the route specific risk is calculated. In this step, the results of step 204 are used to calculate the a dollar value estimates of the value of persons and property at risk along an aircraft route, taking into account the aircraft's physical and operating characteristics. For each grid or geospatial unit though which the route passes, the distance in that grid is weighted by the aircraft physical and operational characteristics to calculate the risk. Speed and distance and mean time between aircraft mishaps are multiplied together to determine the probability of a mishap within a grid. The dollar risk calculation used in this step uses the same formula as in the previously described system components 137, 139. The resulting dollar value estimates calculation is output. The output is digitally transmitted to a user's display device (see 110—FIG. 1), or can be stored in a database (not shown).

In an optional step 208, the route is searched to find segments that have the highest risk. In one embodiment, the risk for each grid segment of the route is search. The segment that is more than a predefined threshold higher than the previous segment is determined. An indication of the segments exceeding the threshold can be sent to the user device 110—FIG. 1 to highlight of the higher risk. The indication means includes but is not limited to highlighting the segment, changing the color, or the width of the route line. Alternatively, the high risk segments are selected by the comparing the segment to the average route risk. Beneficially, a user selecting a route will have an indication of segments to avoid and thereby may be able to select an alternative route avoiding high risk areas.

In an option step 209, an alternative route is calculated. The calculation may be performed by determining a dollar value risk gradient along the route. A negative gradient indicates a route path with lower risk. One skilled in the field of digital optimization would be able to determine one or more paths along the route and computing a risk gradient along the path.

### Alternative Method

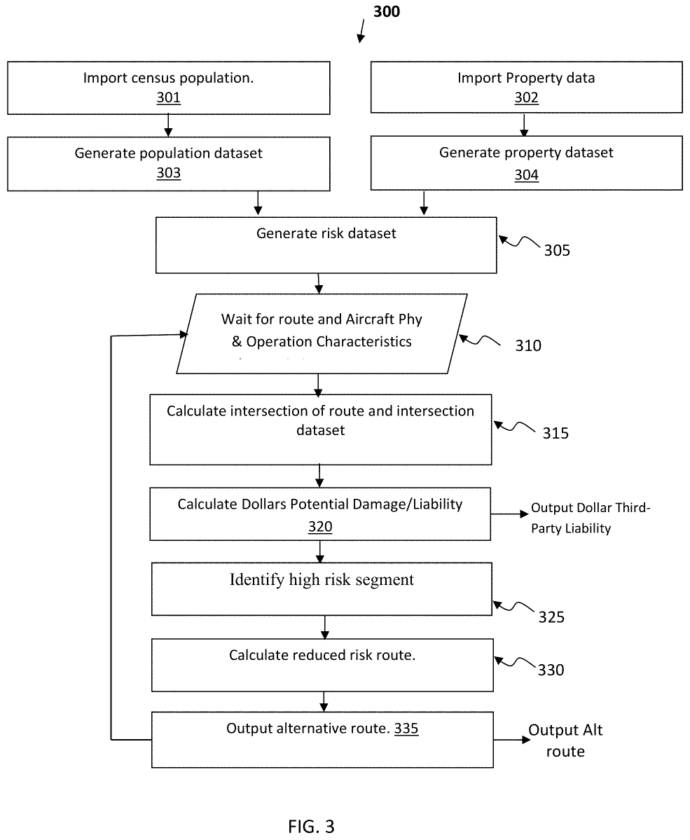

An alternative method generating dollar value estimates of the value of persons and property at risk along an aircraft route, taking into account the aircraft's physical and operating characteristics is shown is FIG. 3. In this method, the property and population data is preprocessed to speed the processing time and reduce the computer resources required.

Referring to FIG. 3, in a step 301 and 302, population dataset and property dataset is downloaded for processing. In a step 303 and 304, the population data and property data is processed into a grid (see FIG. 5). If one of the dataset is an irregular shaped geospatial unit, the mapping into a grid requires determining the percentage of the grid that covers different geospatial units. The property density or population density for each geospatial unit is weighted by the area covered within the grid.

In a step 305, the two dataset are combined to create a single dataset. This combined dataset increases the access speed to population and property data within a grid.

In a step 310, the process waits for a route and aircraft physical and operational characteristics. The route can be specified as longitude and latitude points. The aircraft physical and operational characteristics can include but is not limited to speed, weight, mean time between mishaps, and frangibility.

In a step 315, the process determines which grids from the dataset formed in step 305 are transected by the route and the length of each transect. This data is stored in computer memory as an array for later processing.

In a step 320, the route specific dollar value liability for an aircraft is calculated. The calculation is uses the same formula as specified above for system component 137 and 139. The generated dollar value estimates of the value of persons and property at risk along an aircraft route, taking into account the aircraft's physical and operating characteristics is output user GUI for display.

In an optional step 325, the route grids or geospatial units are searched for the highest estimated liability value. An indication of the segment is generated. This high risk segment can be sent to a GUI to be displayed.

In an optional step 330, the risk gradient along the route is calculated. The gradient is used to identify a lower risk route. This route is output which can be displayed by a GUI. The system then waits for another route to process.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A computer implemented method for generating dollar value risk estimates of the value of persons and property at risk along an aircraft route comprising the steps:
providing a property digital-dataset covering an area comprising a plurality of property-geospatial units within the area, wherein each of the plurality property-geospatial units has an associated property value density;
providing one or more aircraft characteristics, wherein the one or more aircraft characteristics includes the operating characteristics, physical characteristics, and reliability, and wherein the operating characteristics includes aircraft speed;
selecting an aircraft-route within the area, and wherein the aircraft-route has a starting point and an ending point;
associating the aircraft-route with the plurality of property-geospatial units intersected by the aircraft-route and thereby forming a property sub-area set; and
generating an aircraft route property specific dollar value risk estimate based on the one or more aircraft characteristics and the property sub-area set.

14. The method of claim 13, wherein the generating the aircraft route property specific dollar value risk estimate is formed by summing the product of an associated property-mishap probability for each of the property sub-area set times an effective area times a consequence coefficient times the associated property value density, wherein the associated property-mishap probability is proportional to a time spent in the associated property sub-area.

15. The method of claim 14, further comprising the steps:
providing a persons-value population digital-dataset covering the area comprising a plurality of population-geospatial units within the area, wherein each of the population-geospatial units include an associated population density per unit area;
associating the aircraft-route with the plurality of population-geospatial units crossed by the aircraft-route and thereby forming a population sub-area set; and
generating a route population specific dollar value risk estimate based on the one or more aircraft characteristics and the population sub-area set.

16. The method of claim 15, wherein the generating the route population specific dollar value risk estimate is formed by summing the product of the associated population-mishap probability for each of the population sub-areas times an effective area times the consequence coefficient times the associated population density per unit area, wherein the associated population-mishap probability is proportional to the time spent in the associated population sub-area.

17. The method of claim 16, wherein the person value population digital-dataset is generated by mapping census data to each of the population-geospatial units thereby defining a population in each of the plurality of population-geospatial units and multiplying times a life value.

18. The method of claim 17, wherein the aircraft characteristics include the aircraft speed, the aircraft weight, and the aircraft frangibility.

19. The method of claim 18, wherein the plurality of property-geospatial units have a property fixed shape and the population spatial units have a population fixed shape.

20. The method of claim 19, wherein the property fixed shape and the population fixed shape are rectangular.

21. The method of claim 18, wherein the property-geospatial units and population-geospatial units are stored in a dataset with fixed property density values and fixed population density values.

22. The method of claim 21, wherein the aircraft route property specific dollar value risk estimate and the route population specific dollar value risk estimate are aggregated.

23. The method of claim 18, further includes sending the route specific output to an aircraft management system or an aircraft.

24. The method of claim 15, further comprising the step:
generate an aggregated graphical depiction of the aircraft route dollar value risk estimate for each of the property sub-area set, and the route population specific dollar value risk estimate for each of the population sub-area set.

25. A computer system configured for generating a specific aircraft route dollar value risk estimate comprising:
a first software component configured to receive an aircraft-route within an area, the aircraft-route having a starting point and an ending point;
a second software component configured to access one or more aircraft characteristics wherein the aircraft characteristics include the physical characteristics, operating characteristics, and the reliability, wherein the operating characteristics includes aircraft speed;
a third software component configured to access a property digital-dataset covering the area comprising a plurality of property-geospatial units, wherein each of the plurality of property-geospatial units has an associated property value density;
a fourth software component configured to associate the aircraft-route with the plurality of property-geospatial units intersected by data and thereby forming a property sub-area set; and
a fifth software component configured to generate an route specific dollar value risk estimate based on the one or more aircraft characteristics and the property sub-area set.

26. The method of claim 25, wherein the generating the route specific dollar value risk estimate is formed by summing the product of an associated property-mishap probability for each of the property sub-area set times an effective area times a consequence coefficient times the associated property value density, wherein the associated property-mishap probability of mishap is proportional the time spent in the associated property sub-area.

27. The system of claim 26, further comprising:
a sixth software component configured to access a persons-value population digital-dataset covering the area, comprising a plurality of population-geospatial units within the area, wherein each of the population-geospatial units include an associated population density;
a seventh software component configured to associate the aircraft-route with the plurality of population-geospatial units crossed by the population data and thereby forming a population sub area set; and
an eighth software component configured to generate a route population specific dollar value risk estimate based on the one or more aircraft characteristics and the population sub-area set.

28. The system of claim 27, wherein the generating the route population specific dollar value risk estimate is formed by summing the product of the associated population-mishap probability for each of the population sub-areas times an effective area times the consequence coefficient times the associated population density, wherein the associated population-mishap probability is proportional the time spent in the associated population sub-area.

29. The method of claim 28, wherein the person value population digital-dataset is generated by mapping census data to each of the population-geospatial units thereby defining a population in each of the plurality of population-geospatial units and multiplying times a life value.

30. The system of claim 28, wherein the aircraft characteristics include an aircraft speed, an aircraft weight, and aircraft frangibility.

31. The system of claim 30, wherein the time spent in the associated property sub-area is inversely proportional to the aircraft speed.

32. The system of claim 27, wherein at the user's option the aircraft-route is transmitted to an aircraft.
